(19) United States
(12) Patent Application Publication
(10) Pub. No.: US 2010/0176542 A1
(43) Pub. Date: Jul. 15, 2010

(54) FILTER DEVICE FOR MOLTEN METAL FILTRATION

(76) Inventor: Kassim Juma, Staffordshire (GB)

Correspondence Address: PATENTTM.US, P. O. BOX 82788, PORTLAND, OR, 97282-0788, US

(21) Appl. No.: 12/305,812

(22) PCT Filed: May 10, 2007
(86) PCT No.: PCT/GB07/01743

§ 371 Date: Nov. 4, 2009

(30) Foreign Application Priority Data
Jun. 30, 2006 (GB) 0613001.7

(51) Int. Cl. C22B 9/02; B01D 29/00; C04B 33/32

(52) U.S. Cl. 266/227; 264/628

(57) ABSTRACT

A filter for molten metal, the filter comprising a perforated surface and the perforated surface retaining a filter media for contact with a molten metal passing in use across the perforated surface between perforations of the perforated surface.

The present invention relates to filters and more particularly a filter for molten metal filtration in order to remove impurities such as slag, dross and oxides along with fragments of fractured material from the molten metal.

It is known to provide filters and filter devices in the form of ceramic structures having holes or having a porous nature through which a molten metal can pass in order to remove impurities. These filters generally are of either a one off type which have a short operational life of up to few minutes or cast house fitters generally of a much larger size which are arranged to be used for weeks of operational production involving many hundreds of tons of molten product. The filters act by essentially creating a constriction which will trap large solid fragments and also provide a contact area upon which impurities can be deposited.

Traditionally, filters were formed by creating a ceramic sponge like material through which the molten metal would pass, but which presented the significant problem of potential fragmentation of the filter itself introducing contaminants into the molten metal. More recently ceramic mesh and grid filters have been created particularly for use in one off situations where the filters have a generally small cross section and depth. Even more recently European patent publication No. 1369190 has proposed creating a filter formed by two opposed sieve plates incorporating perforations and holes through which the molten metal passes in order to be cleansed in use. These filters are designed for cast house usage and therefore are of a larger size typically up to 60 cm in width and 60 cm in length. Typically, the filter device defined in European patent publication No. 1369190 will be formed using a carbon bonding process as described therein.

It will be understood in use a filter in accordance with aspects of the present invention will be presented with a molten metal flow. The filter itself will have a thermal mass such that with respect to some metals such as aluminium initial presentation of the molten metal may result in that molten metal “freezing” within the filter and therefore blocking the filter. To avoid such freezing and blocking it is known to pre-heat the filters prior to presentation of the molten metal. Such pre-heating with regard to a filter formed by carbon bonding may result in burning and combustion of the carbon within the filter leading to contamination.

As indicated above traditional ceramic sponge thermal filters have particular advantages with regard to providing an open and reticulated interconnective pore structure so that there is extensive contact between the molten metal and the filter surface. The filter is generally open and has a relatively high surface area and so is highly effective with regard to removing slag, sand, refractories and de-oxidation products. Furthermore, small non-metallic particles can be removed from the melt and retained within the filter foam structure. Foam or sponge filters also have a relatively high efficiency for depth filtration. Disadvantages with regard to sponge or foam structure filters are that they are generally expensive compared to other filtration means and are susceptible to low flow rate due to blocking of the inner structure of the filter. Ceramic foam filters also have variable flow rates from filter to filter. Due to the nature of the foam or sponge filter structure they are relatively weak and frangible with bits of the filter continuously breaking in use causing contamination if the melt. In addition with regard to some metals as described above there is the problem that having a high surface area means that there is greater potential for “freezing” of the molten metal in the filter during casting. Again due to the relatively weak structure of the foam or sponge filter there is a possibility of catastrophic break-up leading to part or all of the filter being carried into the casting. Finally, sponge or foam structures are generally limited to sizes less than 200 mm again due to the weakness of the structure.

Pressed ceramic filters have advantages with regard to reduced cost whilst achieving a more consistent and predictable normally higher flow rate with greater strength, dimensions and accuracy than foam filters. Pressed ceramic filters have a solid and coherent structure. Disadvantages which regard to ceramic filters are that they are almost exclusively used for high filtration and due to difficulties with regard to pressing are limited to sizes larger than 150 mm. Pressed ceramic filters tend to block more quickly than foam or sponge filters and as indicated are principally used in relation to molten iron filtration due to the potential of freeze blocking.

As indicated above, filters in accordance with aspects of the present invention will act to remove solid matter through the aperture size of the holes or perforations in the filter as well as through surface contact with the molten metal. It is achieving such filtration with regard to molten metals at the elevated temperatures involved which is a requirement of a filter in accordance with aspects of the present invention.

In accordance with one embodiment of the present invention, there is provided a filter for molten metal, the filter comprising a perforated surface and the perforated surface retaining a filter media for contact with a molten metal passing in use across the perforated surface between perforations of the perforated surface.

Advantageously, the perforated surface is provided by a plate section of a cavity. Possibly, the cavity comprises a recess to accommodate the filter media.

Generally, the cavity is formed within a body comprising opposed plate sections incorporating the perforations.

Typically, the body comprises a shell formed of component parts secured together. Typically, the shell comprises two parts secured together. Possibly, the shell comprises symmetrical parts. Normally, the parts incorporate a recess or recessed portion to form the cavity in the filter once assembled.

Generally, the cavity is shaped to retain the filter media. Possibly, the cavity is shaped by ribs or undulations for retention of position of the filter media within the cavity and/or to provide increased contact with the molten metal.

Advantageously, the filter media is provided by a ceramic foam. Typically, the ceramic foam is encapsulated within a cavity. Possibly, the ceramic foam is secured to one side of the perforated surface. Advantageously the perforated surface has ceramic foam secured to both sides of the perforated surface.

Possibly, the perforations are round or oval or star or square or triangular in cross section.

Possibly, the sides of the filter are protected by a tape. Alternatively; sides of the filter incorporate side proportions to define a recess within which the filter media is located.

Possibly, the filter media comprises irregular elements. Alternatively, the filter media comprises regular elements. Possibly, the filter media comprises irregular and regular elements appropriately positioned to provide contact with molten metal in use. Potentially, the filter media comprises elements of a graded size. Possibly, the filter media comprises layers of particulate material with each layer having a particular nature. Possibly, the filter media acts to cleanse a molten metal flow by wetting with the molten metal in use to cause deposition of contaminants from within the molten metal flow. Possibly, the filter media is chemically active to react with molten metal flow in use. Possibly, the filter media provides inoculation of the molten metal flow with an inoculation constituent.

Generally, the cavity is completely filled with filter media. Generally, the filter media is chosen to ensure filter media composite size is significantly greater than the size of the perforations to prevent fall through.

Potentially, the filter media is presented as an insert located within the cavity. Possibly, the insert is structurally integral to allow modular placing of the insert within the cavity.

Generally, the perforations are evenly distributed. Possibly, the perforations are sized to ensure the filter media is trapped within the cavity. Possibly, the perforations are tapered along their length.

Generally, the filter media comprises one or more of the following alumina (brown fused), white fused alumina, magnesia silica, zirconia, carbon, carbides, nitrides, SiC, ZᵣB_{z}, mullite or any combination of these.

Generally, the filter has a depth between the perforations to provide sufficient filter action upon a molten metal flow in use. Possibly, the cavity is configured to direct molten metal flow in use. Possibly, the cavity has a waisted constriction. Alternatively, the cavity comprises a discus shaped hollow. Possibly, the cavity comprises a flat discontinuity between opposing surfaces incorporating the perforations. Possibly, the cavity has dished walls incorporating the perforations to provide strength.

Possibly, the filter incorporates a plurality of cavities.

Generally, the filter has a press formed peripheral side surface. Advantageously, the filter is shaped to facilitate retention in a plug aperture of a vessel for molten metal in use. Possibly, the filter is shaped to have a tapered side to facilitate retention within the plug aperture.

Advantageously, the filter is formed and stabilised by ceramic bonding or carbon fusion bonding

Typically, the filter is formed from a material chosen from alumina, clay, mullite, aluminium silicate mixed with water and possibly cement along with silica, glass and frits, zirconia magnesia, mullite, and combinations of any ceramic formulation.

Also in accordance with the present invention there is provided a filter for molten metal, the filter comprising a body shaped to form a cavity and the body formed from a suitable material to allow shaping to define the cavity and stabilised with the cavity defined by ceramic bonding or other bonding. Typically, the filter has a construction similar to that described with regard to preceding paragraphs.

Also in accordance with aspects of the present invention there is provided a method of forming a filter for molten metal, the method comprising:
a) creating a filter material by mixing alumina and/or clay and/or mullite and/or aluminium silicate with water and/or cement and/or silica and/or glass and/or frits to allow shaping;
b) shaping the filter material to define a perforated surface in a precursor filter;
c) drying at a drying temperature the precursor filter in an oven until sufficiently water free for firing at a firing temperature for ceramic bonding to stabilise the filter sufficiently for an objective desired end use for the filter.

Generally, the shaping of the filter material includes defining a cavity. Possibly, the cavity is a recess in the perforated surface. Alternatively, the cavity is provided by shaping the perforated surface in a first plate section and associating with a second plate section to provide a closed cavity.

Typically, a fitter media is associated with the perforated surface prior to firing. Alternatively, the filter media is associated to one side of the perforated surface. Possibly, the filter media is associated on both of the perforated surface.

Generally, the filter is shaped for use in association with a plug aperture of a vessel or a conduit.

Typically, the filter material is shaped by pressing, moulding, or slip moulding.

Typically, the filter shaping is provided by more than one precursor filter part and each precursor filter part secured together to define the filter.

Generally, the drying temperature is in the order of 110° C.

Typically, the firing temperature is in the order of 600-1700° C.

Embodiments of the present invention will now be described by way of example and with reference to the accompanying drawings in which:—

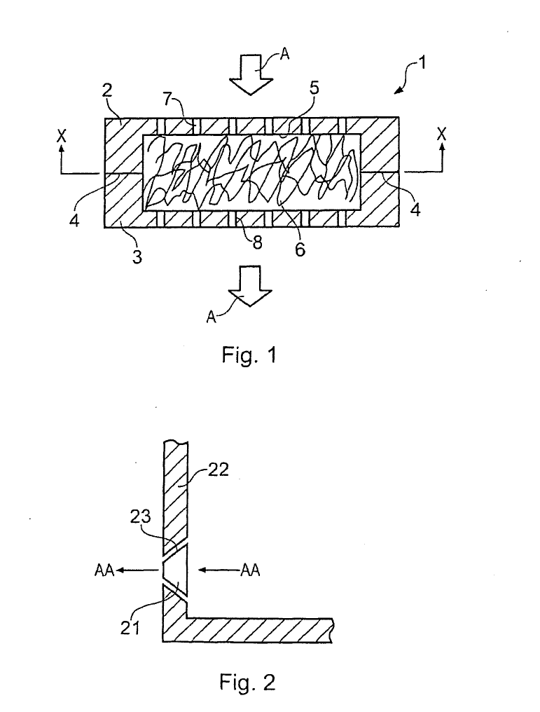

FIG. 1 is a schematic cross section of a filter in accordance with aspects of the present invention;

FIG. 2 is a schematic illustration of a filter in accordance with the present invention incorporated within a vessel for molten metal in accordance with aspects of the present invention;

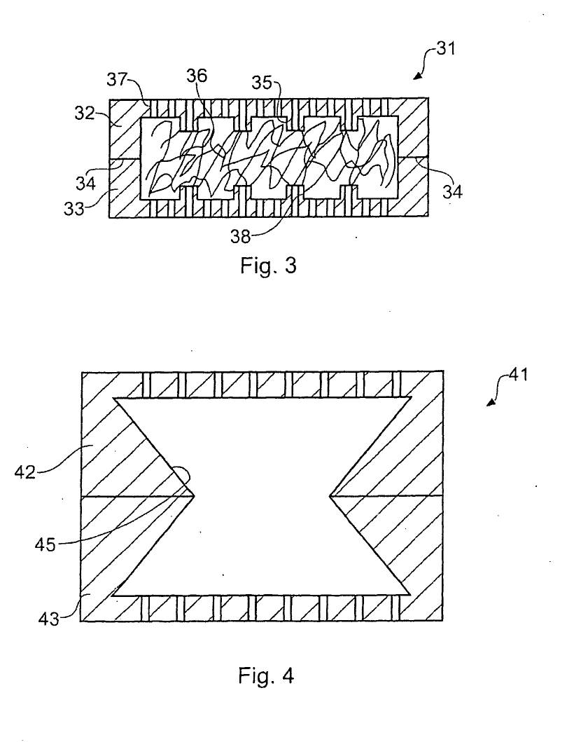

FIG. 3 is a schematic cross section of a half filter shell part incorporating ribs and undulations in order to retain filter media position;

FIG. 4 is a schematic cross section of a filter in accordance with aspects of the present invention incorporating a cavity shaped for filter media retention and/or molten metal flow;

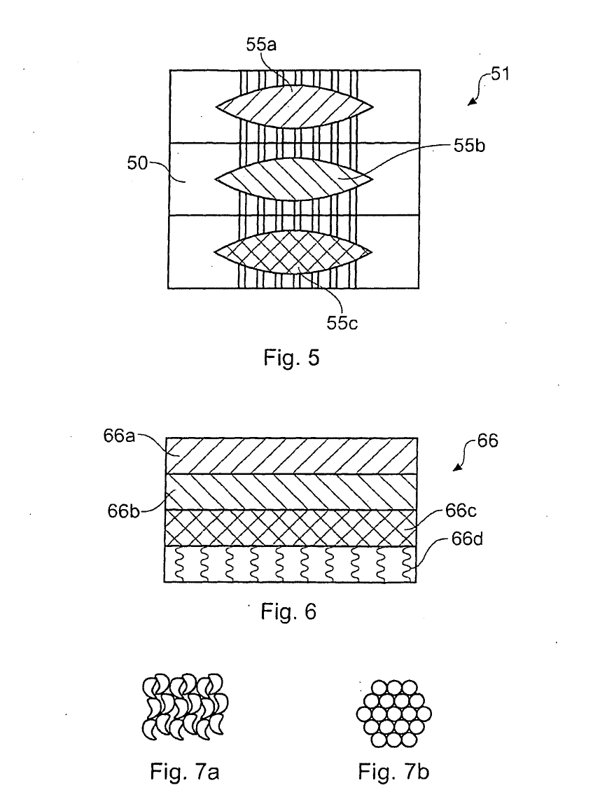

FIG. 5 is a schematic cross section of a filter incorporating several cavities in accordance with aspects of the present invention;

FIG. 6 is a schematic cross section illustrating layers of filter media in accordance with aspects of the present invention;

FIG. 7 is a schematic illustration of respectively a portion of irregular and regular filter media in accordance with aspects of the present invention.

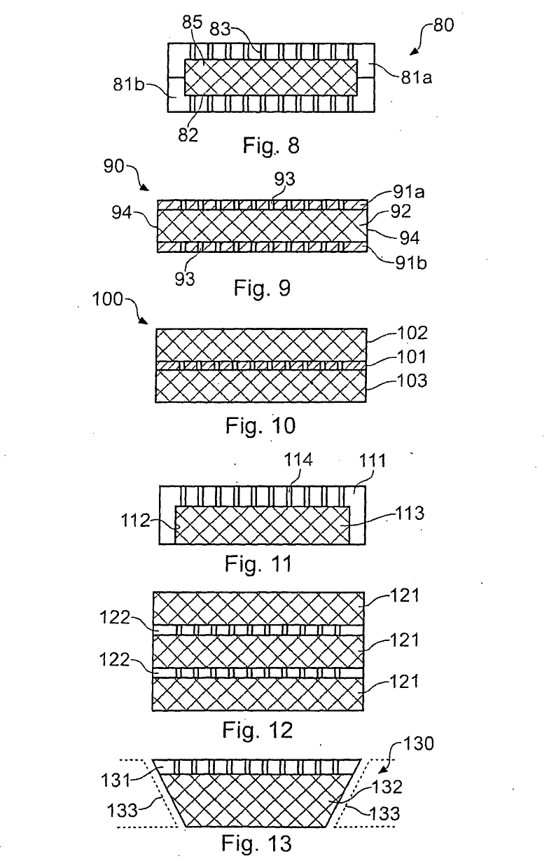

FIG. 8 is a schematic illustration of a filter in accordance with aspects of the present invention incorporating a ceramic foam filter media;

FIG. 9 is a schematic cross section of a further alternative filter in accordance with aspects to the present invention having perforated surface with a ceramic foam filter media secured between;

FIG. 10 is a schematic cross-section of a further alternative filter in accordance with aspects to the present invention in which a perforated surface has a ceramic foam filter media secured to both sides;

FIG. 11 is a schematic side cross section of an additional filter in accordance with aspects to the present invention in which a perforated surface includes a recess as a cavity within which a ceramic foam filter media is secured;

FIG. 12 is a schematic side cross-section of a stack of perforated surfaces and filter media associated together to form a filter; and;

FIG. 13 is a schematic side cross-section of a filter to act as a plug in a vessel in accordance with aspects of the present invention.

As indicated above, filters are utilised with regard to molten metals in order to remove solid debris and contaminants. In accordance with a first aspect of the present invention a filter is provided in the form of a body in which a cavity is formed. In accordance with the first aspect of the present invention, this cavity is filled with a filter media in order to increase the contact area of the filter with the molten metal and therefore deposition of contaminants and impurities. In accordance with a second aspect of the present invention the filter body with cavity is provided by appropriate shaping and forming of the filter body using a filter material having an appropriate composition to allow shaping and then drying to a sufficiently water free composition to allow firing in order to stabilise the filter with ceramic bonding for a desired end use.

As described previously, perforations and holes are provided in the filter to allow the molten metal in use to pass from one side of the filter to the other. The perforations are provided in a perforated surface in a plate forming the filter. FIG. 1 provides a schematic illustration of a filter 1 in accordance with aspects of the present invention. The filter 1 comprises a body as illustrated in the form of two parts 2, 3 secured together in an appropriate manner and possibly utilising an adhesive or fusion bond at an interface 4 between the parts 2, 3. The filter body comprising parts 2, 3 defines a space or a cavity 5 within which, in accordance with the first aspect of the present invention, a filter media 6 is located. The cavity 5 has perforations 7, 8 in plate sections which allow the molten metal to flow in the direction of arrowheads A across the filter 1 initially through the perforations 7 then, cavity 5 and filter media 6 and out of the apertures or perforations 8.

By provision of a filter 1, as indicated, the surfaces of the filter 1, that is to say the perforations 7, 8 and, internal surface of the cavity 5 are supplemented by the filter media 6 in order to increase the contact area with the molten metal flow and so surfaces upon which deposition of contaminants from the molten metal flow can occur. It will be appreciated that a number of techniques can be utilised in order to further increase contact area and wetting for contaminant deposition through the filter 1 including misalignment and different sizing of the apertures or perforations 7, 8 either side of the cavity 5, bending and shaping of the apertures or perforations 7, 8 and shaping of the cavity 5 itself. The filter media 6 can be any suitable material to provide a deposition surface for the particular molten metal. Suitable materials include alumina (brown fused), white fused alumina, fired clay, mullite, silica, inoculants, silicon, magnesia and aluminium.

It will be understood that the filter media may take the form of granular particles of an appropriate size located within the cavity. In order to ensure the filter media itself does not contaminated the molten metal flow, the filter media has a particulate size significantly greater than the width of the apertures or perforations 7, 8 to ensure that the filter media is retained within the cavity 5.

Although granular particles can be utilised to provide a filter media it is advantageous to provide a filter media in the form a ceramic foam having graded pores to achieve the desired level of operational efficiency. The ceramic foam will be formed within the housing defining the filter 1 during drying and the firing stages. Further description with regard to the filter media 6 taking the form of a ceramic foam will be provided with respect to FIGS. 8 to 11 below.

As illustrated, generally, the cavity is fully filled with filter media 6 which may be in a slightly compressed state to ensure robust presentation within the cavity 5. Alternatively, the filter media 6 may only fill a proportion of the cavity 5 and therefore will be allowed to move and flow within the cavity 5 with the molten metal passing across the filter 1. In such circumstances, benefits may be provided with regard to ensuring full utilisation of available filter media 6 surface area for contact with the molten metal flow in order to achieve cleansing and decontamination. However, such movement of the filter media may create agitation and wear within the cavity 5.

Aspects of the present invention have particular applicability with regard to molten metal flows in the form of aluminium or similar metals. These metals, as indicated above, are susceptible to blocking and freezing due to the thermal mass of the filter and therefore it is generally desirable to provide a filter which can be pre-heated to an elevated temperature to inhibit such freezing. Prior utilisation of carbon bonded filters creates problems with respect to the carbon within such filters combusting. In such circumstances, in accordance with one embodiment of the present invention, a filter is provided in which a body or other structure is created having typically two plates with perforations or holes in a sieve like arrangement either side of a cavity or space within which a filter media is retained. The filter structure is simply formed with a cavity defined in a housing ceramic bonding. In such circumstances, the filter and filter media in accordance with the present invention is formed by ceramic bonding to enable pre-heating without the possibility of carbon combustion. Thus, the heated filter can act upon a molten metal flow without freezing within the filter causing blocking and therefore lack of utility. Furthermore, by the filter structure allowing pre-heating there may be long term usage in cast house filtration.

Filters in accordance with aspects of the present invention will be utilised normally in cast house filtration where the filter will be used for extended periods of time, possibly weeks, to provide filtering and cleansing with respect to significant volumes, that is to say several hundred tons of molten metal before replacement of the filter. In such circumstances, the filter must be robustly located. Such location will typically be achieved through external shaping of the filter such that it is keyed or otherwise secured in association with a vessel or conduit for the molten metal flow in use. FIG. 2 provides an example of one means for securing a filter 21 in a wall of a vessel 22 such that the filter 21 is robustly retained against a molten metal flow in the direction of arrowheads AA. As can be seen, the filter 21 has a tapered shape with regard to its external body which fits in a plug aperture 23 of the vessel 22 to ensure robust location. It will be understood that other means of ensuring robust location may be provided. In any event, the underlying cavity within the filter 21 will itself be generally shaped to reciprocate the external shape of the filter 21. To improve strength the walls of the cavity may be dished, that is to say convex or concave.

As indicated above, in a first aspect of the present invention a filter media will be located within a cavity or space formed by the filter typically between perforated or sieve plates. In some circumstances movement of the filter media may be acceptable, but similarly in other circumstances, movement may-cause wear or reduce operational performance. In such circumstances, as illustrated in FIG. 3 the interior surface of the cavity or space may be shaped by inclusion of ribs and undulations to limit filter media movement within the cavity or space. It will also be understood that the cavity may comprise a simple flat discontinuity between surfaces including the perforations of very narrow width.

In FIG. 3 two half shell parts of a filter body or housing in accordance with aspects of the present invention are illustrated. These parts 32, 33 are secured together at interfaces 34 to define a cavity or space 35. As can be seen perforations or holes 37, 38 are provided either side of the cavity 35 which, in accordance with a first aspect of the present invention, includes a filter media 36. This filter media 36, as described previously, will possibly be in particulate or granular form and of appropriate size and potentially similar matched grading such that these particulates or granules are significantly larger then the diameter of the apertures or perforations 37, 38 so that the filter material and media is retained within the cavity 35. In order to prevent movement the surfaces of the cavity 35 incorporate undulations and ribs which should provide constriction within the cavity 36 preventing shifting and movement of the filter material. Alternatively, such problems with loose granules as will be understood by those skilled in the technology can be avoided by having a ceramic foam filter media as described below.

As illustrated above, the perforations 37, 38 may be aligned with each other or, dependent upon requirements, have different alignments and sizes either side of the cavity 35. Furthermore, the diameter, subject to the objective of retaining the media within the cavity 35, of the respective perforations 37, 38 either side of the cavity 35 may be of different sizes. Furthermore, the distribution and number of apertures or perforations 37, 38 may be random or adjusted dependent upon expected molten metal flow in operation.

FIG. 4 illustrates a further alternative with regard to cavity shaping in accordance with aspects of the present invention. As indicated, a filter in accordance with aspects of the present invention attempts to remove contaminants from a molten metal flow. In such circumstances, by providing a dumbbell or bow tie shaping to a cavity 45 in a filter 14 in accordance with aspects of the present invention, it will be understood that a molten metal flow from one side of the cavity 45 to the other will be constricted by the waisted narrowing of the cavity towards the junction of parts 42, 43 of the filter 14 body. In such circumstances, the molten metal flow will be reduced and therefore the molten metal may linger due to flow regulation in association with the cavity and filter material providing additional filtration effects. Alternatively the cavity could be shaped to expand in a waisted portion such that the apertures present the molten metal flow over a reduced area or front into an expanding cavity where the molten metal will again linger for cleaning and filtration effects before exiting through apertures on the other side of the cavity.

Although single cavity filters in accordance with aspects of the present invention can be provided, it will be understood that there are significant benefits with regard to providing cascades of cavities such that the filters have more than one cavity arranged in a flow cascade from one side of the filter to the other. FIG. 5 illustrates one configuration of a filter 15 in accordance with aspects of the present invention in which cavities 55a, 55b, 55c are formed in a filter body. The cavities 55a, 55b, 55c have a discus shape with apertures extending through the filter body from one side of the filter 51 to the other. In formation of the filter 51 side walls 50 are generally rolled and compressed in order to create sufficient structural strength within the filter in view of the reduced overlap between the parts of the filter creating the cavities 55. In any event, in accordance with the first aspect of the present invention, the cavities 55 are filled with a filter media to provide, as described above, additional contact area with the molten metal flow in order to remove by deposition contaminants within the metal.

The size and spacing as well as the filter media located within the cavities 55 may be adjusted in order to improve operational performance. Thus, as previously, the surfaces of the cavities 55 may be shaped with ribs, undulations and contours as well as surface roughening and general profiling to achieve a desired filtering effect upon the molten metal flow to the filter. The respective cavities 55a, 55b, 55c may have differing filter media in terms of nature, that is to say particle sizing and distribution. It will also be understood that a filter media may be packed in different degrees of compression in the respective cavities 55.

It is also envisaged that the filter media in accordance with aspects of the present invention may be chemically active in terms of chemical reactions with the molten metal flow. However, care must be taken with respect to exhaustion of the filter material in such circumstances as well as any detrimental chemical reaction effects. Such chemical action may provide an inoculation of a molten metal flow that is to say addition of inoculation constituent to the molten metal flow. Typically, such inoculation occurs with high alloy iron castings and the inoculation constituent comprises silicon, a titanium alloy, a nickel alloy, a manganese alloy or an aluminium alloy. The inoculation constituent can comprise a coating upon a base filter media or more typically consumable granules or particles in the filter media or a sheet or block of material in the cavity as the part of the filter media in accordance with aspects of the present invention. The inoculation constituent can be added to the molten metal for a variety of eventual material product objectives. Generally, the inoculation constituent is washed or “licked” from within the cavity of the filter and in view of the nature of the molten metal will be distributed through that molten metal. Inoculation is a technique known to those skilled in the art and effectively doses the molten metal with a constituent for desired performance criteria in the eventually formed metal.

As indicated above, generally filters in accordance with aspects of the present invention will be formed from parts or shell parts initially press formed or otherwise shaped and then consolidated to provide the filter part which can then be assembled with other parts in order to create a cavity in accordance with aspects of the present invention. In such circumstances, rather than introducing loose filter material in accordance with aspects of the present invention, on already consolidated or otherwise associated filter media insert may be provided. This insert may comprise the filter media at least partially formed into an appropriate reciprocal shape to the cavity in which it will be located. In such circumstances the respective parts of the filter will be formed and then the insert located within one recess or other part of the filter precursor and then the other part, or parts, overlaid and secured into a consolidated and stabilised form as a filter in accordance with the present invention.

Furthermore, the filter media as indicated above can take the form of a ceramic foam component either initially formed as an insert component to be located within the filter or the ceramic foam filter media created in-situ with the remainder of the filter during firing processes etc.

Where an insert is created for a filter in accordance with aspects of the present invention, it will be understood that that insert may be specifically configured for desired performance. In such circumstances as illustrated in FIG. 6, an insert can be provided in the form of layers of filter material of a different nature appropriately consolidated and held together to form an integral insert for location within a cavity as described above. It will also be understood that, where possible, the filter material may simply be loose laid into a cavity recess in a formed part of the filter and then the filter closed as required. Use of an insert 66 comprising a number of layers 66a, 66b, 66c, 66d may be more convenient as well as easier, to incorporate within a filter.

FIG. 7 illustrates portions of typical filter media in accordance with aspects of the present invention. In FIG. 7a irregularly shaped filter media is illustrated. Although irregularly shaped this filter media will be graded to ensure that the minimum granule or particle size is sufficiently greater than the aperture sizes or the perforations in the filter to ensure that in use the filter media is located within the cavity and not released.

In FIG. 7b regular, in this case, spherical filter media is illustrated. In such circumstances, again the size of the spherical filter media will be chosen such that there is retention due to over sizing relative to the aperture size or perforation in a filter. Other regular filter media shapes may be used.

It will also be understood that regular and irregular filter media may be combined or filter media of different sizes used as long as the minimum size is greater than the perforation aperture size of the perforated surfaces of the inlet and outlet sides of the filter.

As indicated above in accordance with the first aspect to the present invention, the filter will include a cavity or space within which filter media is located. However, creation of a cavity as indicated, will increase contact area with a molten metal flow in any event and therefore filters may be provided in accordance with a second aspect of the present invention which do not necessarily include a filter media but are formed of appropriate materials in order to cause ceramic bonding without the necessity of using techniques such as carbon bonding. Provision of filters of an appropriate size for cast house usage necessitates care with respect to formation. In such circumstances, a typical method of forming a filter precursor, that is to say a part of a filter which will be combined with other filter precursors in order to create a filter assembly or device utilises a material composition including a mix of alumina, clay, mullite, aluminium silicate with silicon, glass and frits with water and, where required to achieve castability, cement. This filter material will be appropriately mixed to achieve an homogenous or approaching an homogenous nature and will be shapeable. In such circumstances, the filler material will be loaded into a mould or otherwise pressed or shaped to a desired filter precursor shape. This desired precursor filter shape will include a recess part which, in combination with other filter precursors, will create the filter cavity in accordance with aspects of the present invention. Subsequent to shaping, the filter precursor will be de-moulded or otherwise released to enable drying. Drying will occur in an oven at a temperature in the order of 110° C. but dependent upon material composition and other factors. The objective of drying is to achieve a sufficiently water free nature to allow subsequent firing of the filter precursor without cracking or degradation. The drying temperature, as indicated, will typically be in the order of 110° C. and will take a few hours. Subsequent to drying the filter precursor is fired, that is to say the ceramic bonding for consolidation and stabilisation of the filter precursor occurs. The firing temperature will typically be in the range of 600-1700° C. or potentially higher in view of the expected temperatures needed for end use of the filter. It will be understood that end use as indicated is with regard to filtration with molten metals and so the end use temperature of the filter will be indicated by the melting point of the molten metal flow to be passed through the filter.

Once appropriately fired and consolidated such that the filter precursor is stabilised, it will be understood that an assembly of filter precursors will be made and bonding between those filter precursors implemented to form the final filter device for assembly. This filter assembly or device, as indicated, will incorporate a cavity. If the cavity is filled in accordance with the first aspect of the present invention with a filter media then this filter media will be introduced into the cavity at the assembly stage either in loose form or as a pre formed insert.

As indicated above although loose granular filter media can be used it is advantageous if the filter media is stabilised. In such circumstances providing the filter media is in the form of ceramic foam has advantageous. FIG. 8 provides a schematic cross section of a filter 80 in which a filter housing or body 81 is provided by two halves 81a, 81b of filter material shaped appropriately to define a cavity 82 within which the filter media in the form of a ceramic foam 85 is located. The filter halves 81 define plates incorporating perforations 83 through which molten metal can flow in use.

In terms of fabrication as previously the parts 81a, 81b will be shaped and formed from a suitable filter material and then a ceramic foam pre-cursor located with the filter halves 81a, 81b. Generally the filter halves 81a, 81b will still be wet or at the dry stage described above such that the ceramic foam pre-cursor can be dried simultaneously with the filter parts 81a, 81b and then fired appropriately to create the filter 80. Alternatively, the parts 81a, 81b may be formed separately along with the ceramic foam 85 as an insert and the whole located together and secured to form the filter 80 by ceramic or adhesive bonding as appropriate.

The ceramic foam pre-cursor takes the form of a reticulated polyurethane foam although other foams may be used such as polystyrene. This reticulated polyurethane foam is impregnated with a ceramic slurry and then dried and possibly resprayed with ceramic slurry to build up an appropriate coating. The foam with ceramic slurry is then fired to create the ceramic foam filter in accordance with known techniques. The firing process will depend up on the ceramic material used for impregnating the foam but will typically be in the range of 900-1300° C. As indicated the ceramic foam precursor can be located within the filter parts 81a, 81b and the whole fired in order to create the filter 81 in accordance with aspects to the present invention.

The particular pore size for the ceramic foam can be chosen depending upon operational requirements.

It will be appreciated that ceramic foam filter media as indicated is substantially stable. In such circumstances as depicted in FIG. 9 it is possible to provide two flat perforated surfaces 91a, 91b in the form of plates. A ceramic foam filter media 92 is located between these surfaces 91 and as previously a molten metal can pass through apertures 93 in the respective surfaces 91 across the filter media 92 in the form of a ceramic foam.

Typically, edges 94 of a filter 90 are bound with tape for protection of the filter media 92 and to prevent ingress of contaminants. This tape will burn off during operational use of the filter 94. It will also be understood that a filter can be made comprising a single perforated surface 91 with the other perforated surface removed such that there is a combination of that single perforated surface 91 and a ceramic foam filter media 92 secured to one side of the perforated surface 91. The filter plug 130 described below with regard to FIG. 13 has such a configuration.

FIG. 10 illustrates a further alternative in which a single perforated surface 101 in the form of a plate has ceramic foam filter media 102, 103 secured either side. In such circumstances again molten metal may pass through the media 102, 103 and the perforated surface 101 provide a filter 100 in accordance with aspects to the present invention.

As indicated above a single perforated surface may be combined with a single layer of filter media in the form of ceramic foam. Such an arrangement may be susceptible to damage particularly with regard to the ceramic foam filter media. In such circumstances to provide protection as depicted in FIG. 11 a perforated surface 111 is arranged to have a recess 112 within which a filter media 113 is secured. In such circumstances the filter media 113 is protected up on three sides and so should be less susceptible to damage. Molten metal will again pass through perforations 114 in the perforated surface 111.

As indicated above typically stacks of perforated surfaces can be combined with layers of filter media in the form of ceramic foam. Thus, as illustrated in FIG. 12 a stack of filter media layers 121 is combined and separated by perforated surfaces 122 in the form of plates. Again the sides of a filter 120 are open and these will be covered with a tape for protection particularly during transportation and storage. Again molten metal will pass through the media 121 and the apertures and perforations in the perforated surfaces 122 in order to provide a filtering function.

As indicated typically filters in accordance with aspects to the present invention will be located at appropriate positions within conduits for molten metal. In such circumstances filters in accordance with aspects to the present invention may be shaped as plugs for locating in reciprocal apertures of a vessel or a conduit. FIG. 13 illustrates a potential plug configuration 130 in which a perforated surface 131 incorporates perforations to present molten metal to a filter media in the form of a ceramic foam layer 132 secured to one side. It will be noted that the sides of perforated surface 131 and the ceramic foam filter media 132 are chamfered and shaped for reciprocal location within a plug aperture of a vessel depicted by broken lines 133.

By aspects to the present invention benefits of pressed formed ceramic filters with foam or sponge filters are combined to achieve additional benefits in terms of filtration and resistance to thermal shock and freezing.

As indicated above, generally filters in accordance with aspects of the present invention will be of a relatively large size with a width up to or greater than 60 cm and a depth in the direction of molten metal flow in the order of up to 60 or more centimetres. In such circumstances provision of a filter assembly comprising a number of filter precursors is advantageous in order to enable a filter to be formed through ceramic bonding. As indicated ceramic bonding due to the nature of the firing temperatures in a large structure, can be susceptible to thermal stressing causing cracks within the structure.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A filter for molten metal, the filter comprising a composite of a perforated filter surface and a stabilized filer media bonded to each other in a fixed orientation, the perforated surface having perforations to direct a molten metal flow to or from the filter media whereby the molten metal flow is subject to a filtering effect by both the perforated filter surface and the filter media.

2. A filter as claimed in claim 1 wherein the perforated surface is provided by a plate section of a cavity.

3. A filter as claimed in claim 2 wherein the cavity comprises a recess to accommodate the filter media.

4. A filter as claimed in claim or claim 3 wherein the cavity is formed within a body comprising opposed plate sections incorporating the perforations.

5. A filter as claimed in claim 4 wherein the body comprises a shell formed of component parts secured together.

6. A filter as claimed in claim 5 wherein the shell comprises two parts secured together.

7. A filter as claimed in claim 5 wherein the shell comprises symmetrical parts.

8. A filter as claimed in claim 5 wherein the parts incorporate a recess or recessed portion to form the cavity in the filter once assembled.

9. A filter as claimed in claim 2 wherein the cavity is shaped to retain the filter medial

10. A filter as claimed in claim 9 wherein the cavity is shaped by ribs or undulations for retention of position of the filter media within the cavity and/or to provide increased contact with the molten metal.

11. A filter as claimed in claim 1 wherein the filter media is provided by a ceramic foam.

12. A filter as claimed in claim 11 wherein the ceramic foam is encapsulated within a cavity.

13. A filter as claimed in claim 11 wherein the ceramic foam is secured to one side of the perforated surface.

14. A filter as claimed in claim 11 wherein the perforated surface has ceramic foam secured to both sides of the perforated surface.

15. A filter as claimed in claim 1 wherein perforations are round or oval or star or square or triangular in cross section.

16. A filter as claimed in claim 1 wherein the sides of the filter are protected by a tape.

17. A filter as claimed in claim 1 wherein the sides of the filter incorporate side proportions to define a recess within which the filter media is located.

18. (canceled)

19. (canceled)

20. (canceled)

21. (canceled)

22. (canceled)

23. (canceled)

24. (canceled)

25. (canceled)

26. A filter as claimed in claim 2 wherein the cavity is completely filled with filter media.

27. A filter as claimed claim 1 wherein the filter media is chosen to ensure filter media composite size is significantly greater than the size of the perforations to prevent fall through.

28. A filter as claimed claim 1 wherein the filter media is presented as an insert located within the cavity.

29. A filter as claimed in claim 28 wherein the insert is structurally integral to allow modular placing of the insert within the cavity.

30. A filter as claimed in claim 1 wherein the perforations are evenly distributed.

31. A filter as claimed in claim 2 wherein the perforations are sized to ensure the filter media is trapped within the cavity.

32. A filter as claimed in claim 1 wherein the perforations are tapered along their length.

33. A filter as claimed in claim 1 wherein the filter media comprises one or more of the following alumina (brown fused), white alumina, magnesia silica, zirconia, carbon, carbides, nitrides, SiC, Z₁B₂, mullite or any combination of these.

34. A filter as claimed in claim 1 wherein the filter has a depth between the perforations to provide sufficient filter action upon a molten metal flow in use.

35. A filter as claimed in claim 2 wherein the cavity is configured to direct molten metal flow in use.

36. A filter as claimed in claim 2 wherein the cavity has a waisted constriction.

37. A filter as claimed in claim 2 wherein the cavity comprises a discus shaped hollow.

38. A filter as claimed in claim 2 wherein the cavity comprises a flat discontinuity between opposing surfaces incorporating the perforations.

39. A filter as claimed in claim 2 wherein the cavity has dished walls incorporating the perforations to provide strength.

40. A filter as claimed in claim 2 wherein the filter incorporates a plurality of cavities.

41. A filter as claimed in claim 1 wherein the filter has a press formed peripheral side surface.

42. A filter as claimed in claim 1 wherein the filter is shaped to facilitate retention in a plug aperture of a vessel for molten metal in use.

43. A filter as claimed in claim 42 wherein the filter is shaped to have a tapered side to facilitate retention within the plug aperture.

44. A filter as claimed in claim 1 wherein the filter is formed and stabilised by ceramic bonding or carbon fusion bonding.

45. A filter as claimed in claim 1 wherein the filter is formed from a material chosen from alumina, clay, mullite, aluminium silicate mixed with water and possibly cement along with silica, glass and frits, zironcia, magnesia, mullite, and combinations of any ceramic formulation.

46. (canceled)

47. (canceled)

48. (canceled)

49. A method of forming a filter for molten metal, the method comprising:
a) creating a filter material by mixing alumina and/or clay and/or mullite and/or aluminium silicate with water and/or cement and/or silica and/or glass and/or frits to allow shaping;
b) shaping the filter material to define a perforated surface in a precursor filter;
c) drying at a drying temperature the precursor filter in an oven until sufficiently water free for firing at a firing temperature for ceramic bonding to stabilise the filter sufficiently for an objective desired end use for the filter;
d) fixing a filter media to the perforated surface to provide a composite comprising the perforated surface and the filter media.

50. A method as claimed in claim 49 wherein the shaping of the filter material includes defining a cavity.

51. A method as claimed in claim 50 wherein the cavity is a recess in the perforated surface.

52. A method as claimed in claim 50 wherein the cavity is provided by shaping the perforated surface in a first plate section and associating with a second plate section to provide a closed cavity with perforations.

53. A method as claimed in claim 49 wherein a filter media is associated with the perforated surface prior to firing.

54. A method as claimed as in claim 53 wherein the filter media is associated to one side of the perforated surface.

55. A method as claimed in claim 49 wherein the filter is shaped for use in association with a plug aperture of a vessel or a conduit.

56. A method as claimed in claim 49 wherein the filter material is shaped by pressing, moulding, or slip moulding.

57. A method as claimed in claim 49 wherein the filter shaping is provided by more than one precursor filter part and each precursor filter part secured together to define the filter.

58. A method as claimed in claim 49 wherein the drying temperature is in the order of 110° C.

59. A method as claimed claim 49 wherein the firing temperature is in the order of 600-1700° C.

60. (canceled)

61. (canceled)
